(19) United States
(12) Patent Application Publication
(10) Pub. No.: US 2012/0177564 A1
(43) Pub. Date: Jul. 12, 2012

(54) HALF-METALLIC ANTIFERROMAGNETIC MATERIAL

(76) Inventors: Hisazumi Akai, Suita-shi (JP); Long Hoang Nguyen, Suita-shi (JP); Masako Ogura, Suita-shi (JP)

(21) Appl. No.: 13/496,300

(22) PCT Filed: Sep. 17, 2010
(86) PCT No.: PCT/JP2010/066176

§ 371 Date: Mar. 15, 2012

(30) Foreign Application Priority Data
Sep. 18, 2009 (JP) 2009-217720

(51) Int. Cl. C01B 7/00; C01G 53/09; C01G 53/08; C01G 49/10; C01G 51/08

(52) U.S. Cl. 423/463

(57) ABSTRACT

A half-metallic antiferromagnetic material that is chemically stable and has a stable magnetic structure is provided.

The half metallic antiferromagnetic material according the present invention is a compound containing two or more magnetic elements and a halogen, the two or more magnetic elements containing a magnetic element having fewer than 5 effective d electrons and a magnetic element having more than 5 effective d electrons.

In addition, a total number of effective d electrons of the two or more magnetic elements is 10 or a value close to 10.

### FIELD OF THE INVENTION

The present invention relates to a half-metallic antiferromagnetic material that has an antiferromagnetic property and that exhibits a property as a metal in one electron spin state of electron spin-up and spin-down states and a property as an insulator or a semiconductor in the other electron spin state of the electron spin-up and spin-down states.

### BACKGROUND OF THE INVENTION

A half-metallic antiferromagnetic property is a concept first proposed by van Leuken and de Groot (see Non-Patent Document 1), and a half-metallic antiferromagnetic material is a substance that exhibits a property of a metal in one electron spin state of electron spin-up and spin-down states and a property of an insulator or a semiconductor in the other electron spin state.

As a half-metallic antiferromagnetic material as described above, various substances have conventionally been proposed. For example, Pickett calculated electronic states of Sr₂VCuO₆, La₂MnVO₆ and La₂MnCoO₆ that have a double perovskite structure, and predicted that, among these intermetallic compounds, La₂MnVO₆ has a likelihood of exhibiting a half-metallic antiferromagnetic property (see Non-Patent Document 2).

Furthermore, the present inventors have proposed various antiferromagnetic half-metallic semiconductors having a semiconductor as a host (see Non-Patent Documents 3 to 7) and have applied for their patents (see Patent Documents 1 and 2). The antiferromagnetic half-metallic semiconductors that the present inventors have proposed can be obtained by substituting, for example, a group II atom of a group II-VI compound semiconductor or a group III atom of a group III-V compound semiconductor with two or more magnetic ions. Specifically, examples thereof include (ZnCrFe)S, (ZnVCo)S, (ZnCrFe)Se, (ZnVCo)Se, (GaCrNi)N and (GaMnCo)N.

### PRIOR ART REFERENCES

### Patent Documents

Patent Document 1: WO 2006/028299
Patent Document 2: JP 2008-047624

### Non Patent Documents

Non-Patent Document 1: van Leuken and de Groot, Phys. Rev. Lett. 74, 1171 (1995)
Non-Patent Document 2: W. E. Pickett, Phys. Rev. B57, 10613 (1998)
Non-Patent Document 3: H. Akai and M. Ogura, Phys. Rev. Lett. 97, 06401 (2006)
Non-Patent Document 4: M. Ogura, Y. Hashimoto and H. Akai, Physica Status Solidi C3, 4160 (2006)
Non-Patent Document 5: M. Ogura, C. Takahashi and H. Akai, Journal of Physics: Condens. Matter 19, 365226 (2007)
Non-Patent Document 6: H. Akai and M. Ogura, Journal of Physics D: Applied Physics 40, 1238 (2007)
Non-Patent Document 7: H. Akai and M. Ogura, Hyperfine Interactions (2008) in press

### DISCLOSURE OF THE INVENTION

### Problems to be Solved by the Invention

The results of our studies, however, show that the intermetallic compound La₂MnVO₆, which has been predicted by Pickett to have a likelihood of exhibiting a half-metallic antiferromagnetic property, has a low likelihood of exhibiting a half-metallic antiferromagnetic property, and if any, it has a low likelihood of having a stable metallic magnetic structure. Furthermore, in the antiferromagnetic half-metallic semiconductor with a semiconductor as a host, a strong attractive interaction exists between magnetic ions; accordingly, magnetic ions form clusters in the host or two-phase separation is caused in an equilibrium state to result in a state where magnetic ions are precipitated in the host. Accordingly, a problem is that it is difficult to assemble a crystal state and to be chemically unstable. Another problem is that owing to weak chemical bond, the magnetic coupling is weak and the magnetic structure is unstable.

In this connection, an object of the present invention is to provide a half-metallic antiferromagnetic material that is chemically stable and has a stable magnetic structure.

### Means for Solving the Problems

A half-metallic antiferromagnetic material according to the present invention is a compound that has two or more magnetic elements and a halogen, the two or more magnetic elements containing a magnetic element having fewer than 5 effective d electrons and a magnetic element having more than 5 effective d electrons, a total number of effective d electrons of the two or more magnetic elements being 10 or a value close to 10.

The number of effective d electrons of a magnetic element is a number obtained by subtracting the number of valence electrons used for bonding with a halogen, from the number of all valence electrons of the magnetic element. Here, the number of all valence electrons of a magnetic element is a value obtained by subtracting the number of core electrons (18 in a 3d transition metal element) from the number of electrons in the atom (atomic number).

Half-metallic antiferromagnetic materials according to the present invention include, for example, CrFeI₄. Since Cr and Fe form a bind with the most adjacent halogen in a ratio of 1:2, respectively, and a halogen is monovalent, the number of effective d electrons of Cr (atomic number: 24) and Fe (atomic number: 26) are 4 (=24−18−2) and 6 (=26−18−2), respectively.

The reason why the compound according to the present invention develops a half-metallic antiferromagnetic property is considered as follows. In the following description, a case where two magnetic elements are contained will be described.

In a nonmagnetic state of a compound represented by a composition formula ABX₄ (A and B each represent a magnetic element and X represents a halogen), as shown in FIG. 15, a bonding sp state and an antibonding sp state that s states and p states of the magnetic element A and the magnetic element B form together with an s state and a p state of the element X each form a band and therebetween a band made of a d state of the magnetic element A and a d state of the magnetic element B is formed.

A d orbital of the magnetic element A and a d orbital of the magnetic element B are spin split owing to an interelectronic interaction. At that time, as a magnetic state, a state where a local magnetic moment of the magnetic element A and a local magnetic moment of the magnetic element B are aligned in parallel with each other and a state where a local magnetic moment of the magnetic element A and a local magnetic moment of the magnetic element B are aligned in antiparallel with each other are considered. In addition, a paramagnetic state where local magnetic moments are aligned in arbitrary directions and also other complicated states can be considered. However, it is enough only to study two states where local magnetic moments are aligned in parallel and in antiparallel with each other. In a state where a local magnetic moment of the magnetic element A and a local magnetic moment of the magnetic element B are aligned in parallel with each other, as shown in FIG. 16, a band (d band) made of a d state is exchange split to exhibit a band structure of a typical ferromagnetic material. Here, an energy gain when local magnetic moments are aligned in parallel with each other is generated by a slight expansion of the band, and the expansion of the band is generated by hybridizing a d state of the magnetic element A and a d state of the magnetic element B, which are different in energy. To generate a band energy gain by hybridizing between different energy states is called a superexchange interaction. When a hopping integral that represents an intensity of hybridization of d states between the magnetic element A and the magnetic element B is assigned to t, an energy gain E1 obtained by aligning local magnetic moments in parallel with each other is represented by the following Formula 1.

E1=−|t|²/D (Formula 1)

Here, D represents an energy difference of d orbitals of the magnetic elements A and B and takes a larger value as the difference of the numbers of effective d electrons between the magnetic element A and the magnetic element B becomes larger.

On the other hand, in a state where a local magnetic moment of the magnetic element A and a local magnetic moment of the magnetic element B are aligned in antiparallel with each other, as shown in FIG. 17, a band made of d states is spin split to exhibit a band structure different from a state where local magnetic moments are aligned in parallel. An energy gain when local magnetic moments are aligned in antiparallel with each other is generated when d states of the magnetic element A and magnetic element B energetically degenerated in a spin-up band are strongly hybridized to form a bonding d state and an antibonding d state and electrons mainly occupy the bonding d state. Thus, to obtain a band energy gain by hybridizing between energetically degenerated states is called a double exchange interaction. An energy gain E2 owing to the double exchange interaction is proportional to −t when the hopping integral is represented by t. Furthermore, in a spin-down band, an energy gain owing to the superexchange interaction is generated in a manner similar to the case of the ferromagnetic property.

While an energy gain due to the superexchange interaction is proportional to a second-order of the hopping integral t (secondary perturbation), an energy gain due to the double exchange interaction is linearly proportional to a first-order of the hopping integral t (primary perturbation when degeneration is caused). Accordingly, in general, a larger energy gain is generated by the double exchange interaction than by the superexchange interaction. In order to generate the double exchange interaction, d states have to be degenerated, and, in a state where local magnetic moments are aligned in antiparallel with each other, when a total number of effective d electrons of the magnetic element A and the number of effective d electrons of the magnetic element B is 10 that is the number of maximum occupying electrons of a 3d electron orbital or a value close to 10, such degeneracy is caused.

As mentioned above, when a total number of effective d electrons is 10 or a value close to 10, a case where local magnetic moments of A and B are aligned in antiparallel with each other is advantageous from energy point of view. Furthermore, in a spin-down band that is subjected to an effect of large exchange splitting corresponding to twice the ferromagnetic exchange splitting, as shown in FIG. 17, a large gap is generated and a Fermi energy locates in the vicinity of a center of an energy gap.

From what was mentioned above, a compound according to the present invention can be said to have a high likelihood of developing a half-metallic antiferromagnetic property in the ground state.

In addition, in the case where a total number of effective d electrons of two magnetic elements is a value close to 10, since magnitudes of magnetic moments of both magnetic elements are slightly different, it is considered to develop a ferrimagnetic property having a slight magnetic property as a whole. In the claims and the specification of the present application, “a ferrimagnetic material not having magnetization” and “a ferrimagnetic material having slight magnetization” are included in “an antiferromagnetic material”.

Furthermore, in the case where a total number of effective d electrons of three or more magnetic elements is a value close to 10, similarly, it is considered to develop a half-metallic antiferromagnetic property.

Specifically, the half metallic antiferromagnetic material has a cadmium iodide type or a cadmium chloride type crystal structure.

In a compound which has a cadmium iodide type or a cadmium chloride type crystal structure, two halogens will be coordinated per each of magnetic elements. Furthermore, a cadmium iodide type crystal structure and a cadmium chloride type crystal structure are 6-coordinated, and a material having a crystal structure of 6-coordination possesses an insulator-like property with regards to an s-state or p state. A band made of a d-state of the magnetic element comes in a region where a band gap was originally present. Among a spin-up band and a spin-down band, in one spin band, an original band gap remains to develop a half-metallic property. Furthermore, although a d-state of the magnetic element is hybridized with surrounding negative ions, a property of a d-state as an atomic orbital is retained and stable antiferromagnetic property is developed with large magnetic splitting and local magnetic moment remained.

The half-metallic antiferromagnetic material according to the present invention is not in a state where magnetic ions precipitate in a host like a half-metallic antiferromagnetic semiconductor with a semiconductor as a host but a compound obtained by chemically bonding a halogen and a magnetic element together. The bond thereof is sufficiently strong and it can also be said to be a stable compound from calculation of formation energy. In addition, it is also known that many similar transition metal halides exist stably.

Furthermore, since a chemical bond between a magnetic ion and a halogen is strong, also a chemical bond between magnetic ions via a halogen is strong. Here, a magnetic coupling is due to magnetic moment among chemical bonds and can be said that the stronger the chemical bond is, the stronger also the magnetic coupling is. Accordingly, the half-metallic antiferromagnetic material according to the present invention can be said to be strong in the magnetic coupling and stable in a magnetic structure.

A patent application has been filed by the present inventors with regard to a half-metallic antiferromagnetic chalcogenide comprising two or more magnetic elements and a chalcogen, and a half-metallic antiferromagnetic pnictide comprising two or more magnetic elements and a pnictogen (Japanese Patent Application No. 2008-073917). Now, in contrast to a chalcogen and a pnictogen that are divalent and trivalent respectively, a halogen is monovalent. Therefore, a compound (a halide) according to the present invention does not have a chemical composition of ABX₂ (A and B each is a magnetic element, and X is a chalcogen or pnictogen) like a half metallic antiferromagnetic chalcogenide and a half metallic antiferromagnetic pnictide, but has a chemical composition of ABX₄ as described above. For this reason, the distance between the magnetic elements in a compound according to the present invention is greater, by 15% or more, than that in the chalcogenide and the pnictide, contributing significantly to exchange splitting of a magnetic element. On the other hand, since anions therein are twice as much as those in the chalcogenide and the pnictide, a metal-like broad band is secured, and a high magnetic transition temperature is obtained. Furthermore, since highly ionic halides are coordinated, crystal field splitting is not large, and a high-spin state is maintained. From what was mentioned above, a compound according to the present invention is considered to be more stable than the chalcogenide and the pnictide, and also easily prepared.

It can be theoretically explained that a compound according to the present invention can develop a half metallic antiferromagnetic property as described above. However, whether it actually develops a half metallic antiferromagnetic property will not be confirmed before performing the first principle electronic state calculation as described below.

Specifically, the half metallic antiferromagnetic material is comprised of two magnetic elements and a halogen, the two magnetic elements being any one of the combinations of Cr and Fe, V and Co, and Ti and Ni. As described above, since the number of effective d electrons of Cr (atomic number: 24) and Fe (atomic number: 26) are 4 (=24−18−2) and 6 (=26−18−2) respectively, the total number of them is 10. In addition, since the number of effective d electrons of V (atomic number: 23) and Co (atomic number: 27) are 3 (=23−18−2) and 7 (=27−18−2) respectively, the total number of them is 10. Moreover, since the number of effective d electrons of Ti (atomic number: 22) and Ni (atomic number: 28) are 2 (=22−18−2) and 8 (=28−18−2) respectively, the total number of them is 10.

### Advantage of the Invention

According to the present invention, a half-metallic antiferromagnetic material that exists chemically stably and has a stable magnetic structure can be realized.

### BRIEF DESCRIPTION OF THE DRAWINGS

FIG. 1 is a graph illustrating an electronic state density in an antiferromagnetic state of CrFeI₄ having a CdI₂ type crystal structure.

FIG. 2 is a graph illustrating an electronic state density in an antiferromagnetic state of CrFeBr₄ having a CdI₂ type crystal structure.

FIG. 3 is a graph illustrating an electronic state density in an antiferromagnetic state of CrFeCl₄ having a CdCl₂ type crystal structure.

FIG. 4 is a graph illustrating an electronic state density in an antiferromagnetic state of VCoCl₄ having a CdCl₂ type crystal structure.

FIG. 5 is a graph illustrating an electronic state density in an antiferromagnetic state of VCoBr₄ having a CdI₂ type crystal structure.

FIG. 6 is a graph illustrating an electronic state density in an antiferromagnetic state of VCoI₄ having a CdI₂ type crystal structure.

FIG. 7 is a graph illustrating an electronic state density in an antiferromagnetic state of TiNiI₄ having a CdCl₂ type crystal structure.

FIG. 8 is a graph illustrating an electronic state density in an antiferromagnetic state of TiNiBr₄ having a CdCl₂ type crystal structure.

FIG. 9 is a graph illustrating an electronic state density in an antiferromagnetic state of CrFeCl₄ having a CdI₂ type crystal structure.

FIG. 10 is a graph illustrating an electronic state density in an antiferromagnetic state of CrFeI₄ having a CdCl₂ type crystal structure.

FIG. 11 is a graph illustrating an electronic state density in an antiferromagnetic state of TiNiBr₄ having a CdI₂ type crystal structure.

FIG. 12 is a graph illustrating an electronic state density in an antiferromagnetic state of TiNiCl₄ having a CdI₂ type crystal structure.

FIG. 13 is a graph illustrating an electronic state density in an antiferromagnetic state of VCoBr₄ having a CdCl₂ type crystal structure.

FIG. 14 is a graph illustrating an electronic state density in an antiferromagnetic state of VCoCl₄ having a CdI₂ type crystal structure.

FIG. 15 is a conceptual diagram of a state density curve in a non-magnetic state of a compound represented by a composition formula ABX₄.

FIG. 16 is a conceptual diagram of a state density curve in a ferromagnetic state of the above compound.

FIG. 17 is a conceptual diagram of a state density curve in an antiferromagnetic state of the above compound.

### DETAILED DESCRIPTION OF THE INVENTION

In what follows, an embodiment of the present invention will be specifically described along the drawings.

A half metallic antiferromagnetic material according to the present invention is an intermetallic compound that has a cadmium iodide (CdI₂) type or cadmium chloride (CdCl₂) type crystal structure, and that is constituted of two or more magnetic elements and a halogen. The two or more magnetic elements contain a magnetic element having fewer than 5 effective d electrons and a magnetic element having more than 5 effective d electrons, and a total number of effective d electrons of the two or more magnetic elements is 10 or a value close to 10. Here, the halogen is any element of Cl, Br and I.

Specifically, a half-metallic antiferromagnetic material is constituted of two transition metal elements and a halogen and represented by a composition formula ABX₄ (A and B: transition metal elements, X: halogen). Here, the two transition metal elements are any one combination of Cr and Fe, V and Co and Ti and Ni. In addition, a half-metallic antiferromagnetic material can also be constituted of three or more transition metal elements and a halogen.

The half-metallic antiferromagnetic material according to the present invention can be prepared according to a solid state reaction process. In the preparation step, powderized magnetic elements and halogen are thoroughly mixed, followed by encapsulating in a quartz glass tube and by heating at 1000° C. or more, further followed by annealing. In addition, it can also be prepared by the laser abrasion method.

The half-metallic antiferromagnetic material according to the present invention is not in a state where magnetic ions precipitate in a host like a half-metallic antiferromagnetic semiconductor with a semiconductor as a host, but a compound obtained by chemically bonding a halogen and a magnetic element together. The bond thereof is sufficiently strong and it can also be said to be a stable compound from calculation of formation energy. In addition, it is also known that many similar transition metal halides exist stably.

Furthermore, since a chemical bond between a magnetic ion and a halogen is strong, also a chemical bond between magnetic ions via a halogen is strong. Here, a magnetic coupling is due to magnetic moment among chemical bonds and it can be said that the stronger the chemical bond is, the stronger also the magnetic coupling is. Accordingly, the half-metallic antiferromagnetic material according to the present invention can be said strong in the magnetic coupling and stable in a magnetic structure.

Furthermore, the half-metallic antiferromagnetic material according to the present invention can be readily prepared as mentioned above.

A half-metallic antiferromagnetic material, being a substance of which Fermi surface is 100% spin split, is useful as a spintronic material. Furthermore, since a half-metallic antiferromagnetic material has no magnetization, it is stable to external perturbation and since it does not generate magnetic shape anisotropy, it has a high likelihood of readily realizing a spin flip by current or spin injection. As a result it is expected to be applied in a broader field such as a high performance magnetic memory and a magnetic head material.

### FIRST EXAMPLE

The half metallic antiferromagnetic material of the present Example is a transition metal halide having a CdI₂ type (hexagonal) crystal structure and represented by the composition formula CrFeI₄.

In order to confirm that the transition metal halide of the present Example has a half-metallic antiferromagnetic property, the present inventors conducted a first principle electronic state calculation. Here, as a method of the first principle electronic state calculation, a known KKR-CPA-LDA method obtained by combining a KKR (Korringa-kohn-Rostoker) method (also called a Green function method), a CPA (Coherent-Potential Approximation) method and an LDA (Local-Density Approximation) method was adopted (Monthly publication “Kagaku Kogyo, Vol. 53, No. 4(2002)” pp. 20-24, and “Shisutemu/Seigyo/Joho, Vol. 48, No. 7” pp. 256-260).

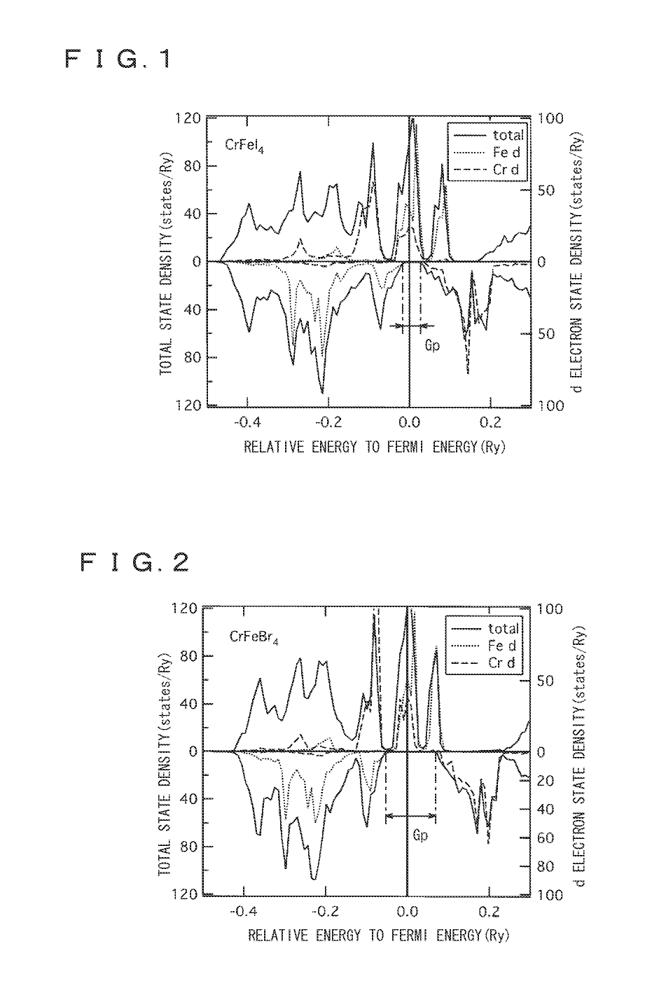

FIG. 1 represents a state density curve in an antiferromagnetic state obtained by conducting the first principle electronic state calculation of CrFeI₄ having a CdI₂ type crystal structure. In the figure, a solid line represents a total state density, a dotted line represents a local state density at a 3d orbital position of Fe, and a broken line represents a local state density at a 3d orbital position of Cr.

As shown with a solid line in the figure, a state density of spin-down electrons is zero to form a band gap Gp and a Fermi energy exists in the band gap. On the other hand, a state density of spin-up electrons is larger than zero in the vicinity of the Fermi energy. Thus, while a state of spin-down electrons exhibits a property of a semiconductor, a state of spin-up electrons exhibits a property of a metal, that is, it can be said that a half-metallic property is developed. Furthermore, when a total state density of spin-up electrons and a total state density of spin-down electrons were each integrated up to the Fermi energy, both integral values were the same; accordingly, it can be said that magnetic moments of Fe and Cr cancel out each other and thereby magnetization is zero as a whole and that an antiferromagnetic property is developed. Moreover, the difference between the energy in a paramagnetic state obtained from the states density curve in a paramagnetic state (hereinafter referred to as the paramagnetic state energy) and the energy in a ferromagnetic state obtained from the states density curve in a ferromagnetic state (hereinafter referred to as the ferromagnetic state energy) was calculated and found to be −0.0059236 Ry, and the difference between the paramagnetic energy and the energy in a antiferromagnetic state obtained from the states density curve in a antiferromagnetic state (hereinafter referred to as the antiferromagnetic state energy) was calculated and found to be −0.0088222 Ry; accordingly, it can be said that the antiferromagnetic state is a stable magnetic structure. Therefore, it can be said that the transition metal halide of the present Example has a half metallic antiferromagnetic property.

Furthermore, a magnetic transition temperature (Neel temperature) where an antiferromagnetic state transitions to a paramagnetic state was calculated and found to be 464 K. Here, the Neel temperature was calculated according to a known method in which the temperature is obtained by evaluating the difference between the energy in a paramagnetic state and the energy in a antiferromagnetic state (J. Phys.: Condens. Matter 19 (2007) 365215, Physica Status Solidi C3, (2006) 4160 (2006)).

### SECOND EXAMPLE

The half metallic antiferromagnetic material of the present Example is a transition metal halide having a CdI₂ type (hexagonal) crystal structure and represented by the composition formula CrFeBr₄.

FIG. 2 represents a state density curve in an antiferromagnetic state obtained by conducting the first principle electronic state calculation of CrFeBr₄ having a CdI₄ type crystal structure. In the figure, a solid line represents a total state density, a dotted line represents a local state density at a 3d orbital position of Fe, and a broken line represents a local state density at a 3d orbital position of Cr. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0085131 Ry, and the difference between the paramagnetic state energy and the antiferromagnetic state energy was calculated and found to be −0.0120155 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 632 K.

### THIRD EXAMPLE

The half metallic antiferromagnetic material of the present Example is a transition metal halide having a CdCl₂ type (near-cubic trigonal) crystal structure and represented by the composition formula CrFeCl₄.

FIG. 3 represents a state density curve in an antiferromagnetic state obtained by conducting the first principle electronic state calculation of CrFeCl₄ having a CdCl₂ type crystal structure. In the figure, a solid line represents a total state density, a dotted line represents a local state density at a 3d orbital position of Fe, and a broken line represents a local state density at a 3d orbital position of Cr. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0178482 Ry, and the difference between the paramagnetic state energy and the antiferromagnetic state energy was calculated and found to be −0.0203808 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 1072 K.

### FOURTH EXAMPLE

The half metallic antiferromagnetic material of the present Example is a transition metal halide having a CdCl₂ type (near-cubic trigonal) crystal structure and represented by the composition formula VCoCl₄.

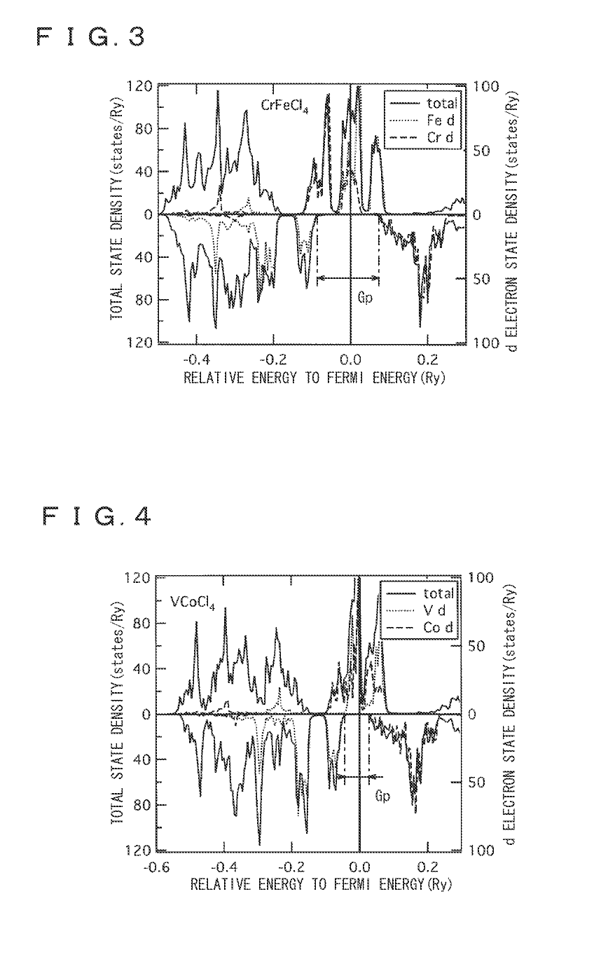

FIG. 4 represents a state density curve in an antiferromagnetic state obtained by conducting the first principle electronic state calculation of VCoCl₄ having a CdCl₂ type crystal structure. In the figure, a solid line represents a total state density, a dotted line represents a local state density at a 3d orbital position of V, and a broken line represents a local state density at a 3d orbital position of Co. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetic moments of V and Co cancel out each other and thereby magnetization is zero as a whole and that an antiferromagnetic property is developed. Moreover, the difference between the paramagnetic state energy and the ferromagnetic state energy was calculated and found to be −0.0018847 Ry, and the difference between the paramagnetic state energy and the antiferromagnetic state energy was calculated and found to be −0.0027309 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 143 K.

### FIFTH EXAMPLE

The half metallic antiferromagnetic material of the present Example is a transition metal halide having a CdI₂ type (hexagonal) crystal structure and represented by the composition formula VCoBr₄.

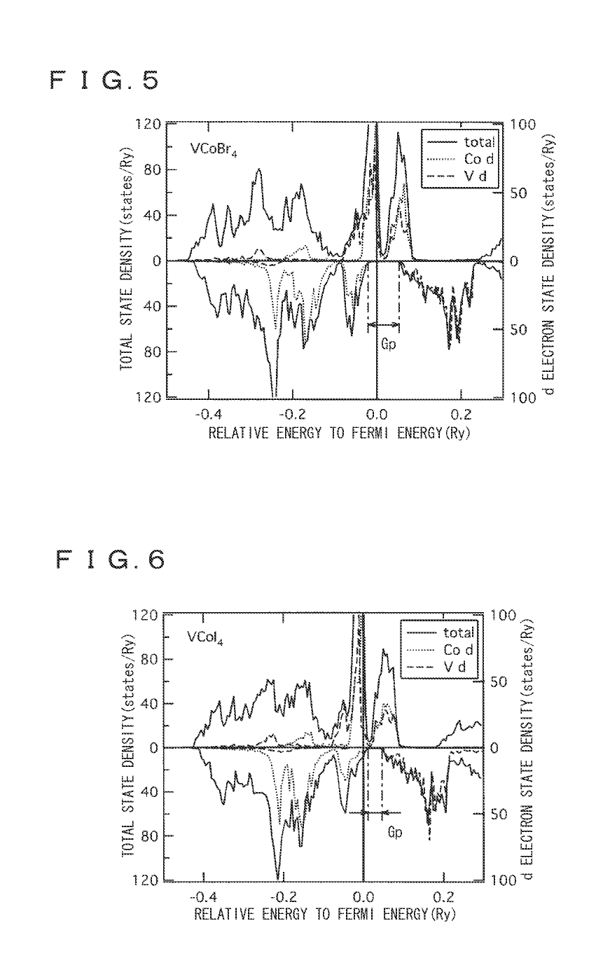

FIG. 5 represents a state density curve in an antiferromagnetic state obtained by conducting the first principle electronic state calculation of VCoBr₄ having a CdI₄ type crystal structure. In the figure, a solid line represents a total state density, a dotted line represents a local state density at a 3d orbital position of Co, and a broken line represents a local state density at a 3d orbital position of V. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0015616 Ry, and the difference between the paramagnetic state energy and the antiferromagnetic state energy was calculated and found to be −0.0023763 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and

### SIXTH EXAMPLE

The half metallic antiferromagnetic material of the present Example is a transition metal halide having a CdI₂ type (hexagonal) crystal structure and represented by the composition formula VCoI₄.

FIG. 6 represents a state density curve in an antiferromagnetic state obtained by conducting the first principle electronic state calculation of VCoI₄ having a CdI₄ type crystal structure. In the figure, a solid line represents a total state density, a dotted line represents a local state density at a 3d orbital position of Co, and a broken line represents a local state density at a 3d orbital position of V. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0008055 Ry, and the difference between the paramagnetic state energy and the antiferromagnetic state energy was calculated and found to be −0.0011057 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 58 K.

### SEVENTH EXAMPLE

The half metallic antiferromagnetic material of the present Example is a transition metal halide having a CdCl₂ type (near-cubic trigonal) crystal structure and represented by the composition formula TiNiI₄.

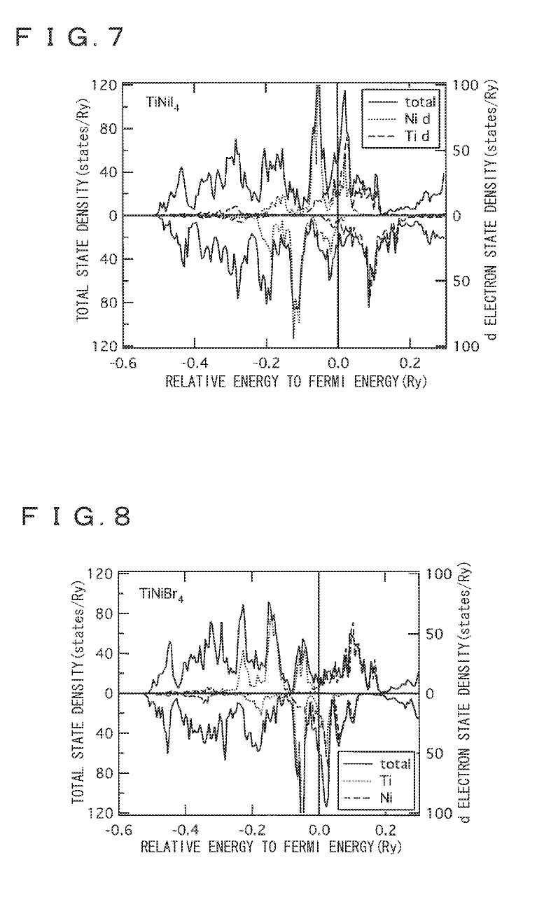

FIG. 7 represents a state density curve in an antiferromagnetic state obtained by conducting the first principle electronic state calculation of TiNiI₄ having a CdCl₂ type crystal structure. In the figure, a solid line represents a total state density, a dotted line represents a local state density at a 3d orbital position of Ni, and a broken line represents a local state density at a 3d orbital position of Ti.

According to the state density curve shown with a solid line in the figure, a half metallic property is not developed in the range of the local-density approximation. On the other hand, when a total state density of spin-up electrons and a total state density of spin-down electrons were each integrated up to the Fermi energy, both integral values were the same; accordingly, it can be said that magnetic moments of Ni and Ti cancel out each other and thereby magnetization as a whole is zero, and that an antiferromagnetic property is developed.

Moreover, the difference between the paramagnetic state energy and the ferromagnetic state energy was calculated and found to be −0.0053210 Ry, and the difference between the paramagnetic state energy and the antiferromagnetic state energy was calculated and found to be −0.0066595 Ry; accordingly, it can be said that the antiferromagnetic state is a stable magnetic structure. Furthermore, the Neel temperature was calculated and found to be 350 K.

As mentioned above, a half metallic property is not developed in the range of the local-density approximation. However, halides of Ni and Fe are known as a system which is in the vicinity of the metal-insulator transition and significantly affected by the interaction between electrons. For the system like this, the local-density approximation tends to underestimate exchange splitting. When the self-interaction correction etc. is performed to correct this problem, it is expected that a half metallic property is developed. Therefore, it can be said that the transition metal halide of the present Example has a high likelihood of developing a half metallic antiferromagnetic property.

### EIGHTH EXAMPLE

The half metallic antiferromagnetic material of the present Example is a transition metal halide having a CdCl₂ type (near-cubic trigonal) crystal structure and represented by the composition formula TiNiBr₄.

FIG. 8 represents a state density curve in an antiferromagnetic state obtained by conducting the first principle electronic state calculation of TiNiBr₄ having a CdCl₂ type crystal structure. In the figure, a solid line represents a total state density, a dotted line represents a local state density at a 3d orbital position of Ti, and a broken line represents a local state density at a 3d orbital position of Ni.

According to the state density curve shown with a solid line in the figure, a half metallic property is not developed in the range of the local-density approximation. On the other hand, when a total state density of spin-up electrons and a total state density of spin-down electrons were each integrated up to the Fermi energy, both integral values were the same; accordingly, it can be said that magnetization as a whole is zero and that an antiferromagnetic property is developed.

Moreover, the difference between the paramagnetic state energy and the ferromagnetic state energy was calculated and found to be +0.0007029 Ry, and the difference between the paramagnetic state energy and the antiferromagnetic state energy was calculated and found to be −0.0009824 Ry; accordingly, it can be said that the antiferromagnetic state is a stable magnetic structure. Furthermore, the Neel temperature was calculated and found to be 51 K.

As mentioned above, a half metallic property is not developed in the range of the local-density approximation. However halides of Ni and Fe are known as a system which is in the vicinity of the metal-insulator transition, and significantly affected by the interaction between electrons. For the system like this, the local-density approximation tends to underestimate exchange splitting. When the self-interaction correction etc. is performed to correct this problem, it is expected that a half metallic property is developed. Therefore, it can be said that the transition metal halide of the present Example has a high likelihood of developing a half metallic antiferromagnetic property.

### NINTH EXAMPLE

The half metallic antiferromagnetic material of the present Example is a transition metal halide having a CdI₂ type (hexagonal) crystal structure and represented by the composition formula CrFeCl₄.

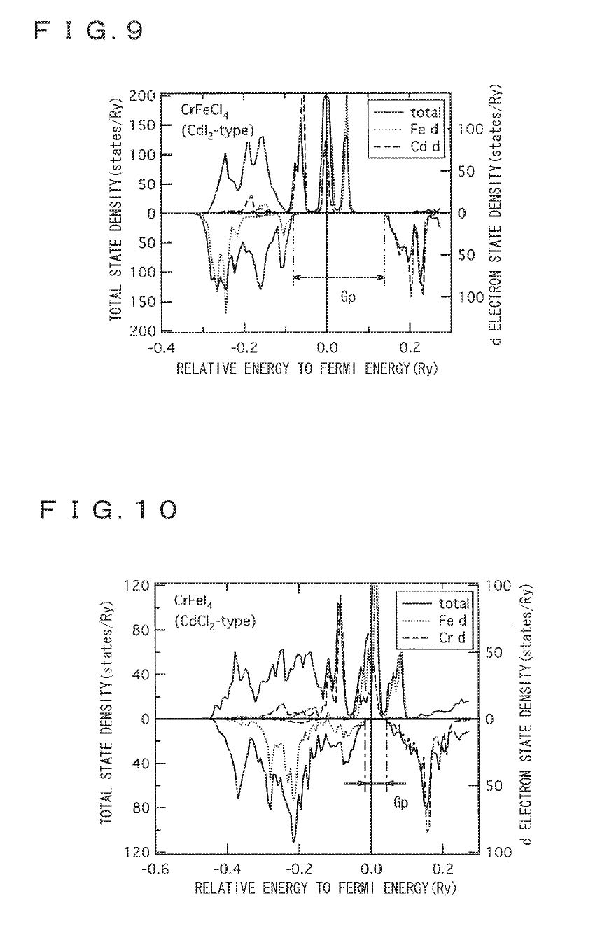

FIG. 9 represents a state density curve in an antiferromagnetic state obtained by conducting the first principle electronic state calculation of CrFeCl₄ having a CdCl₂ type crystal structure. In the figure, a solid line represents a total state density, a dotted line represents a local state density at a 3d orbital position of Fe, and a broken line represents a local state density at a 3d orbital position of Cr. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0085766 Ry, and the difference between the paramagnetic state energy and the antiferromagnetic state energy was calculated and found to be −0.0102102 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 537 K.

### TENTH EXAMPLE

The half metallic antiferromagnetic material of the present Example is a transition metal halide having a CdCl₂ type (near-cubic trigonal) crystal structure and represented by the composition formula CrFeI₄.

FIG. 10 represents a state density curve in an antiferromagnetic state obtained by conducting the first principle electronic state calculation of CrFeI₄ having a CdCl₂ type crystal structure. In the figure, a solid line represents a total state density, a dotted line represents a local state density at a 3d orbital position of Fe, and a broken line represents a local state density at a 3d orbital position of Cr. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0078931 Ry, and the difference between the paramagnetic state energy and the antiferromagnetic state energy was calculated and found to be −0.0103427 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 550 K.

### ELEVENTH EXAMPLE

The half metallic antiferromagnetic material of the present Example is a transition metal halide having a CdI₂ type (hexagonal) crystal structure and represented by the composition formula TiNiBr₄.

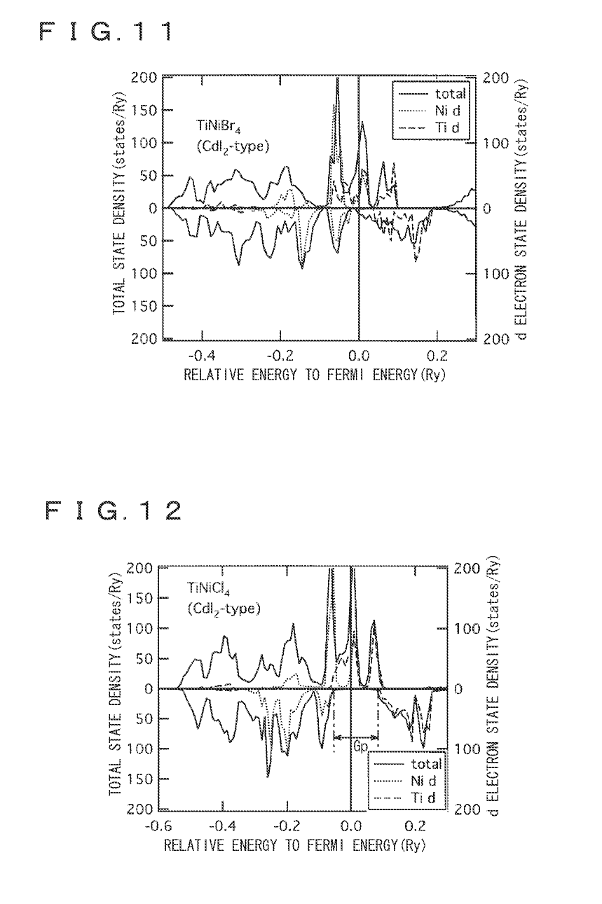

FIG. 11 represents a state density curve in an antiferromagnetic state obtained by conducting the first principle electronic state calculation of TiNiBr₄ having a CdI₂ type crystal structure. In the figure, a solid line represents a total state density, a dotted line represents a local state density at a 3d orbital position of Ni, and a broken line represents a local state density at a 3d orbital position of Ti.

From the state density curve shown with a solid line in the figure, it cannot be said that a half-metallic property is developed although a property that is very similar to a half-metallic property is developed in the range of the local-density approximation. On the other hand, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0040625 Ry, and the difference between the paramagnetic state energy and the antiferromagnetic state energy was calculated and found to be −0.0063391 Ry; accordingly, it can be said that the antiferromagnetic state is a stable magnetic structure. Furthermore, the Neel temperature was calculated and found to be 333 K.

As mentioned above, a half metallic property is not developed in the range of the local-density approximation. However halides of Ni and Fe are known as a system which is in the vicinity of the metal-insulator transition and significantly affected by the interaction between electrons. For the system like this, the local-density approximation tends to underestimate exchange splitting. When the self-interaction correction etc. is performed to correct this problem, it is expected that a half metallic property is developed. Therefore, it can be said that the transition metal halide of the present Example has a high likelihood of developing a half metallic antiferromagnetic property.

### TWELFTH EXAMPLE

The half metallic antiferromagnetic material of the present Example is a transition metal halide having a CdI₂ type (hexagonal) crystal structure and represented by the composition formula TiNiCl₄.

FIG. 12 represents a state density curve in an antiferromagnetic state obtained by conducting the first principle electronic state calculation of TiNiCl₄ having a CdI₂ type crystal structure. In the figure, a solid line represents a total state density, a dotted line represents a local state density at a 3d orbital position of Ni, and a broken line represents a local state density at a 3d orbital position of Ti. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0055737 Ry, and the difference between the paramagnetic state energy and the antiferromagnetic state energy was calculated and found to be −0.0062529 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 329 K.

### THIRTEENTH EXAMPLE

The half metallic antiferromagnetic material of the present Example is a transition metal halide having a CdCl₂ type (near-cubic trigonal) crystal structure and represented by the composition formula VCoBr₄.

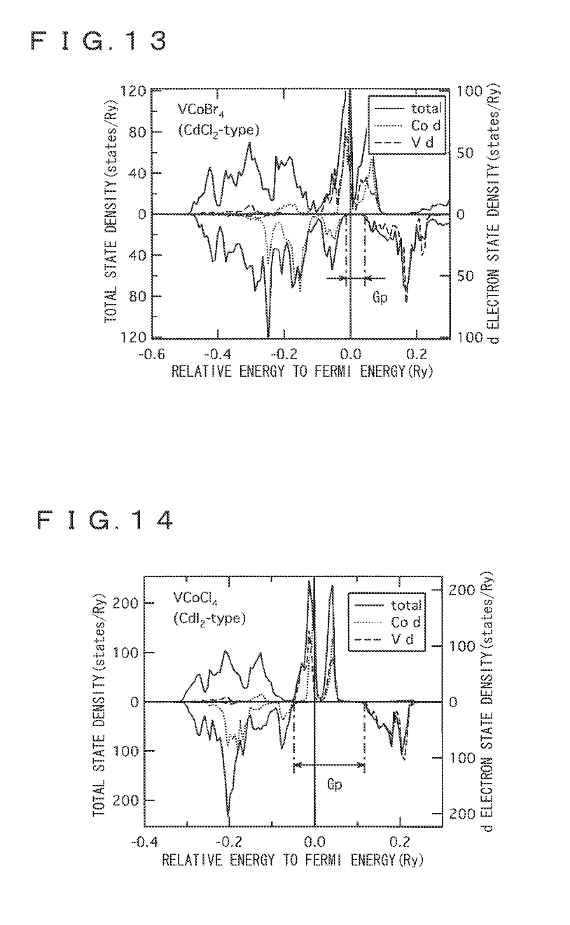

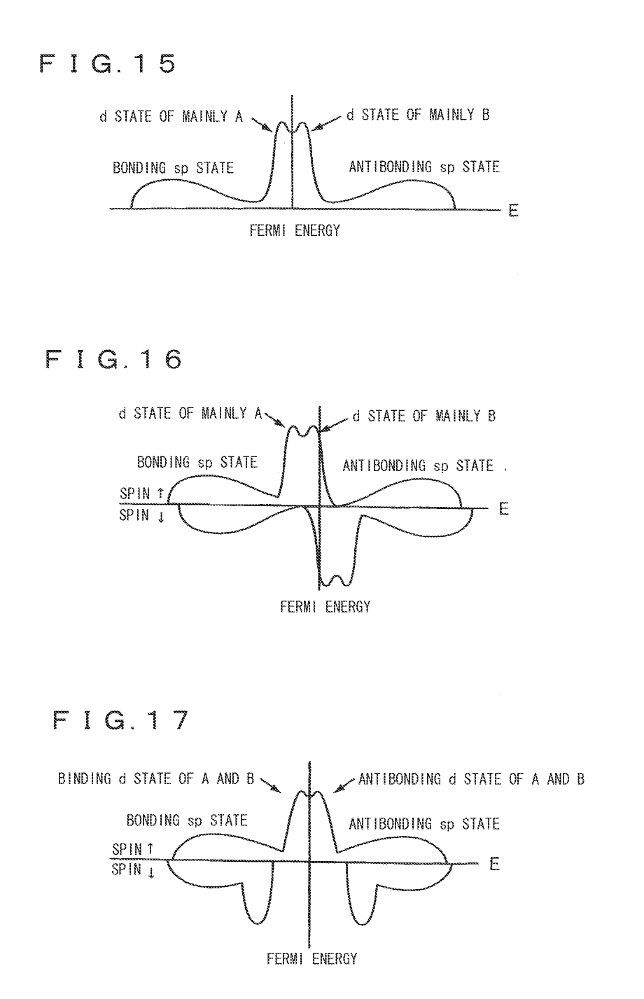

FIG. 13 represents a state density curve in an antiferromagnetic state obtained by conducting the first principle electronic state calculation of VCoBr₄ having a CdCl₂ type crystal structure. In the figure, a solid line represents a total state density, a dotted line represents a local state density at a 3d orbital position of Co, and a broken line represents a local state density at a 3d orbital position of V. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0014354 Ry, and the difference between the paramagnetic state energy and the antiferromagnetic state energy was calculated and found to be −0.0018137 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 95 K.

### FOURTEENTH EXAMPLE

The half metallic antiferromagnetic material of the present Example is a transition metal halide having a CdI₂ type (hexagonal) crystal structure and represented by a composition formula VCoCl₄.

FIG. 14 represents a state density curve in an antiferromagnetic state obtained by conducting the first principle electronic state calculation of VCoCl₄ having a CdI₄ type crystal structure. In the figure, a solid line represents a total state density, a dotted line represents a local state density at a 3d orbital position of Co, and a broken line represents a local state density at a 3d orbital position of V. From the state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero and that an antiferromagnetic property is developed. Moreover, the difference between the paramagnetic state energy and the ferromagnetic state energy was calculated and found to be −0.0051663 Ry, and the difference between the paramagnetic state energy and the antiferromagnetic state energy was calculated and found to be −0.0062961 Ry; accordingly, it can be said that the antiferromagnetic state is a stable magnetic structure. Therefore, it can be said that the transition metal halide of the present Example has a half metallic antiferromagnetic property.

Furthermore, the Neel temperature was calculated and found to be 278 K.

The half metallic antiferromagnetic material according to the present invention is chemically stable and has a stable magnetic structure. In particular, the transition metal halides in First Example to Third Example, Ninth Example, Tenth Example and Twelfth Example described above have a Neel temperature exceeding room temperature, and thus a device using these can stably operate at room temperature; accordingly they are promising as a half metallic antiferromagnetic material.

In addition, a half metallic antiferromagnetic property may be developed even for combinations other than the above combinations of two or more magnetic elements and a halogen for which the first principle electronic state calculations were performed.

1. A half-metallic antiferromagnetic material comprising two or more magnetic elements and a halogen, the two or more magnetic elements containing a magnetic element having fewer than 5 effective d electrons and a magnetic element having more than 5 effective d electrons, a total number of effective d electrons of the two or more magnetic elements being 10 or a value close to 10.

2. The half metallic antiferromagnetic material according to claim 1, having a cadmium iodide type or a cadmium chloride type crystal structure.

3. The half metallic antiferromagnetic material according to claim 1, comprising two magnetic elements and a halogen.

4. The half metallic antiferromagnetic material according to claim 3, wherein the two magnetic elements are any one combination of Cr and Fe, V and Co and Ti and Ni.

5. The half metallic antiferromagnetic material according to claim 1, wherein the halogen is any element of chlorine, bromine and iodine.

6. The half metallic antiferromagnetic material according to claim 2, comprising two magnetic elements and a halogen.

7. The half metallic antiferromagnetic material according to claim 6, wherein the two magnetic elements are any one combination of Cr and Fe, V and Co and Ti and Ni.

8. The half metallic antiferromagnetic material according to claim 2, wherein the halogen is any element of chlorine, bromine and iodine.

9. The half metallic antiferromagnetic material according to claim 3, wherein the halogen is any element of chlorine, bromine and iodine.

10. The half metallic antiferromagnetic material according to claim 4, wherein the halogen is any element of chlorine, bromine and iodine.

11. The half metallic antiferromagnetic material according to claim 6, wherein the halogen is any element of chlorine, bromine and iodine.

12. The half metallic antiferromagnetic material according to claim 7, wherein the halogen is any element of chlorine, bromine and iodine.
